(19) United States
(12) Patent Application Publication
(10) Pub. No.: US 2016/0073690 A1
(43) Pub. Date: Mar. 17, 2016

(54) ELECTRONIC CIGARETTE

(71) Applicant: KIMREE HI-TECH INC., Tortola (VG)

(72) Inventor: QIUMING LIU, Shenzhen City, Guangdong Province (CN)

(21) Appl. No.: 14/344,055

(22) PCT Filed: Apr. 9, 2013
(86) PCT No.: PCT/CN2013/073947

§ 371 Date: Mar. 10, 2014

(51) Int. Cl. A24F 47/00; H05B 3/42; H05B 1/02; H05B 3/06; A24D 3/08; A24D 3/10

(52) U.S. Cl. CPC A24F 47/008; A24D 3/08; A24D 3/10; H05B 1/0297; H05B 3/06; H05B 3/42

(57) ABSTRACT

The present invention provides an electronic cigarette includes a smoke pole having a chamber, a smoke oil accommodating assembly used for storing smoke oil, an atomization assembly used for atomizing the smoke oil; and a smoke nozzle assembly. The smoke nozzle assembly, the smoke oil accommodating assembly and the atomization assembly are orderly assembled in the chamber of the smoke pole. The smoke nozzle assembly includes a seal ring used for isolating the smoke nozzle assembly and the smoke oil, and at least two filters used for filtering. The seal ring has air-through hole. The at least two filters are sequentially arranged at one side of the seal ring and communicate with the air-through pipe located at another side of the seal ring via the air-through hole. The at least two layers of filter can improve the filtering effect, effectively filter out harmful ingredients

### FIELD OF THE INVENTION

The present invention relates to an electronic cigarette, in particularly, to an electronic cigarette with filters.

### BACKGROUND OF THE INVENTION

As a hobby, cigarettes are widely welcomed by people, especially by men. However, the tar in cigarettes is harmful to human health, and most of them are carcinogens. Furthermore, second-hand smoking is even more harmful to non-smokers. So, Most public places have banned smoking regulations. But for smokers, it is very difficult to quit smoking. Therefore, a lot of cigarette substitutes have been marketed to replace cigarettes, such as electronic cigarette.

Electronic cigarette, also known as virtual cigarette, electronic atomizer, is mainly used for quitting smoking and replacing cigarettes. Electronic cigarette has the same appearance and similar taste to cigarettes, and it also can be suck out smoke, taste and feelings like cigarettes. But electronic cigarette has no tobacco tar, aerosols and other harmful ingredients. By atomizing nicotine liquid effectively, electronic cigarette preserves the traditional way of smoking puff features when smoking, and it satisfies the habits of smokers at the most. Some electronic cigarettes are equipped with filters, which can filter some harmful substances from the atomized liquid, thus further reduce harmful of the electronic cigarettes to human health.

However, the current electronic cigarettes with filters set a single layer filter only. The single layer filter will result in insufficient filtering effect, and then it is difficult to meet the performance requirements and individual needs. Furthermore, in only one layer of the filter, when the user inhales a certain number of smokings can easily discolored the surface of the filter, resulting in reduced filtering effect, but also enables users to electronic cigarettes produce adverse reactions.

### SUMMARY OF THE INVENTION

The present invention is to solve the technical problem as: to provide an electronic cigarette, which can improve the filtering effect of the electronic cigarettes.

To achieve the above-mentioned object, the present invention provides an electronic cigarette including a smoke pole with a chamber, a smoke oil accommodating assembly used for storing smoke oil, an atomization assembly used for atomizing the smoke oil, and a smoke nozzle assembly. The smoke nozzle assembly, the smoke oil accommodating assembly and the atomization assembly are sequentially assembled in the chamber of the smoke pole. There is an air-through pipe capable of guiding atomized smoke oil from the atomization assembly to the smoke nozzle assembly disposed between the smoke nozzle assembly and the atomization assembly. One end of the air-through pipe is connected with the atomization assembly, and the other end of the air-through pipe extends into the smoke nozzle assembly. The smoke nozzle assembly includes a seal ring used for isolating the smoke nozzle assembly and the smoke oil, and at least two filters used for filtering. The seal ring has air-through holes. The at least two filters are orderly arranged at one side of the seal ring and connected with the air-through pipe located at another side of the seal ring via the air-through hole.

In a further embodiment of the electronic cigarette of the present invention, any one of the at least two layers of filters is made of chemical fiber, sponge, or breathable foam material.

In a further embodiment of the electronic cigarette of the present invention, the chemical fiber includes cellulose acetate fiber, polypropylene fibers, polyester fibers, acetate fibers, viscose fibers, polyamide fibers, polyacrylonitrile fibers, or polyvinyl fiber.

In a further embodiment of the electronic cigarette of the present invention, the cross-section of any one of the at least two layers of filters is circular, oval, triangular or polygonal.

In a further embodiment of the electronic cigarette of the present invention, any one of the at least two layers of filters has fragrance layer to provide fragrance.

In a further embodiment of the electronic cigarette of the present invention, the smoke oil accommodating assembly includes tubular storing cotton used for storing smoke oil. The storing cotton has through center hole, an oil guiding cotton is assembled in the center hole, the air-through pipe passes through the oil guiding cotton, a fixing pipe is disposed between the air-through pipe and the oil guiding cotton , the atomization assembly partially extends into the air-through pipe.

In a further embodiment of the electronic cigarette of the present invention, the atomization assembly includes a battery, an atomization seat, and a heating wire assembly electrically connected with the battery, the atomization seat includes a bottom seat, a center protruding block protruding from a middle of the bottom seat, the center protruding block extends into the air-through pipe, the heating wire assembly passes through the atomization seat and also extends into the air-through pipe, the air-through pipe has hole in a side wall corresponding to the heating wire assembly.

In a further embodiment of the electronic cigarette of the present invention, the atomization seat has a cup wall around the center protruding block, the cup wall and the center protruding block secure one end of the storing cotton and the oil guiding cotton.

In a further embodiment of the electronic cigarette of the present invention, the smoke pole has a microphone and light cap at one end thereof contrary to the smoke nozzle assembly.

The advantages of the present invention are: the suction nozzle assembly has at least two layers of filters, which are sequentially arranged on one side of the seal rings, and connected with the air-through pipe at the other side of the seal ring through the air-through hole. The at least two layers of filters can improve the filtering effect, effectively filter out harmful ingredients such as fiberglass FeiXu and etc. Comparing to single layer filter of prior art easily causing discoloration, the present invention uses at least two layers of filters, appearance color of which will not change with the users sucking out a certain number of smokings, and thus effectively prevents the filters discoloration and benefit to long-term use of the electronic cigarettes.

Embodiments of the present invention will be further described in detail in the following drawings.

### BRIEF DESCRIPTION OF THE DRAWINGS

FIG. 1 is a cross-sectional view of two layers of filters assembled of an electronic cigarette of an embodiment of the present invention.

FIG. 2 is a perspective view of the electronic cigarette of the embodiment of the present invention.

### DETAILED DESCRIPTION OF THE INVENTION

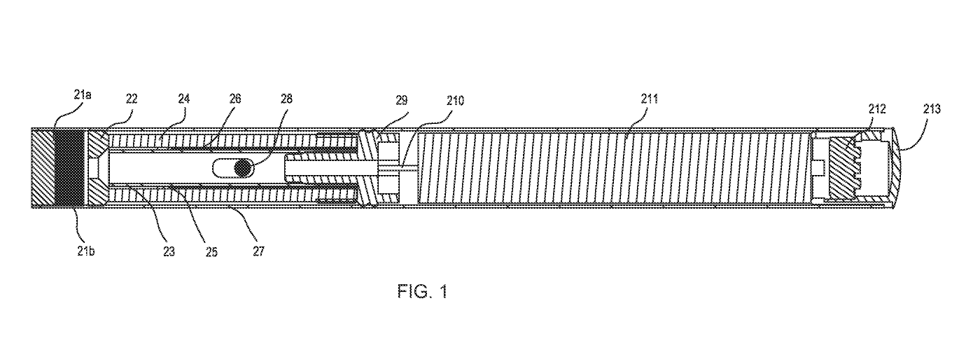

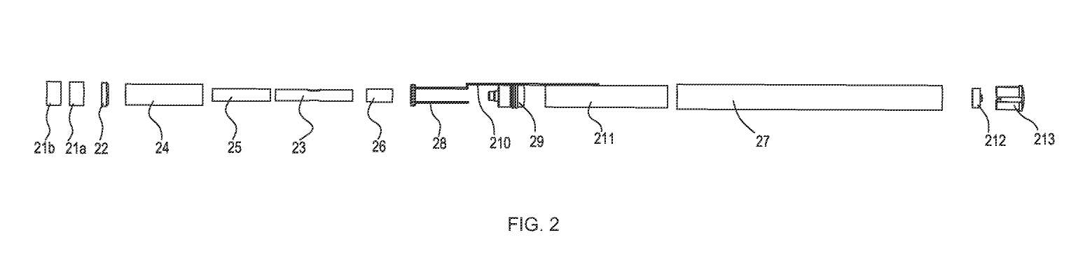

Referring to FIG. 1 and FIG. 2, an embodiment of the present invention provides an electronic cigarette, which includes a smoke pole 27, a smoke oil accommodating assembly, an atomization assembly, and a smoke nozzle assembly are set inside the smoke pole 27. The smoke pole 27 has a chamber. The smoke oil accommodating assembly, the atomization assembly, and the smoke nozzle assembly are sequentially assembled in the chamber of the smoke pole 27. The smoke oil accommodating assembly is used for storing smoke oil. The atomization assembly is used for atomizing the smoke oil. An air-through pipe 23 capable of guiding atomized smoke oil from the atomization assembly to the smoke nozzle assembly is disposed between the smoke nozzle assembly and the atomization assembly. One end of the air-through pipe 23 is connected with the atomization assembly, and the other end of the air-through pipe 23 extends into the smoke nozzle assembly.

In this embodiment, the smoke nozzle assembly includes two layers of filters 21a, 21b, and a seal ring 22. The seal ring 22 is disposed between the filter 21b and the air-through pipe 23 to act as sealing effect, thereby preventing smoke oil to be sucked into the smoke nozzle assembly. The seal ring 22 has air-through hole defined through the middle thereof. The two layer of filters 21a, 21b are sequentially arranged at one side of the seal ring, and communicate with the air-through pipe located at the other side of the seal ring via the air-through hole so as to filer the atomized smoke oil from the air-through pipe twice, and filter out harmful substance, and also prolong lifetime of the electronic cigarette.

Certainly, in other embodiments, more layers of filters may be selected to use. In the case of using more layers of filters, the filtering effect will be improved accordingly.

In a further embodiment, any one of the two layers of filters can be made of chemical fiber, sponge, or breathable foam material, which includes the following technology proposal: only one of the filters is made of chemical fiber, sponge, or breathable foam material, and includes the following technology proposal: the two filters are all made of chemical fiber, sponge, or breathable foam material. For the latter technology proposal, the two filters may be made of same material of chemical fiber, sponge, or breathable foam material, or may be respectively made of any one of chemical fiber, sponge, or breathable foam material.

In a further embodiment, the chemical fiber of the present invention includes cellulose acetate fiber, polypropylene fibers, polyester fibers, acetate fibers, viscose fibers, polyamide fibers, polyacrylonitrile fibers, or polyvinyl formal fiber and etc.

In a further embodiment, the cross-section of any one of the two layers of filters is circular, oval, triangular or polygonal. Similarly, the above-mentioned embodiment includes the following technology proposal: the cross-section of only one of the filters is circular, oval, triangular or polygonal, and includes the following technology proposal: the cross-sections of the two filters are all circular, oval, triangular or polygonal. For the latter technology proposal, cross-section of the two filters may be same shape of circular, oval, triangular or polygonal, or may be different circular, oval, triangular or polygonal respectively.

In a further embodiment, any one of two layers of filters has fragrance layer to provide fragrance. Users can select the type of the fragrance according to different tastes.

Referring also FIG. 1 and FIG. 2, the smoke oil accommodating assembly includes a tubular storing cotton 24 used for storing smoke oil. The storing cotton 24 is disposed in the smoke pole 27 and at one side of the seal ring 22. The storing cotton 24 has through center hole. An oil guiding cotton 25 is assembled in the center hole and used for guiding oil. The air-through pipe 23 passes through the oil guiding cotton 25. A fixing pipe 26 is disposed between the air-through pipe 23 and the oil guiding cotton 25. The atomization assembly partially extends into the air-through pipe 23.

The atomization assembly includes a battery 211, an atomization seat 29, and a heating wire assembly 28 connected with the battery 211. The heating wire assembly 28 is electrically connected with the battery 211 via electric wires 210. The atomization seat 29 includes a bottom seat, a center protruding block protruding from a middle of the bottom seat. The center protruding block extends into the air-through pipe 23. The heating wire assembly 28 passes through the atomization seat 29 and also extends into the air-through pipe 23. The air-through pipe 23 has a hole in a side wall corresponding to the heating wire assembly 28.

In order to secure the storing cotton 24 and the oil guiding cotton 25, the atomization seat 29 has a cup wall around the center protruding block. The cup wall and the center protruding block sandwich and secure one end of the storing cotton 24 and the oil guiding cotton 25 adjacent to the atomization seat 29. The smoke pole has a microphone and light cap at one end thereof contrary to the smoke nozzle assembly.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette, comprising:
a smoke pole with a chamber;
a smoke oil accommodating assembly used for storing smoke oil;
an atomization assembly used for atomizing the smoke oil; and
a smoke nozzle assembly; the smoke nozzle assembly, the smoke oil accommodating assembly and the atomization assembly being sequentially assembled in the chamber of the smoke pole, an air-through pipe capable of guiding atomized smoke oil from the atomization assembly to the smoke nozzle assembly being disposed between the smoke nozzle assembly and the atomization assembly, one end of the air-through pipe connected with the atomization assembly, and the other end of the air-through pipe extending into the smoke nozzle assembly;
wherein the smoke nozzle assembly includes a seal ring used for isolating the smoke nozzle assembly and the smoke oil, and at least two layers of filters used for filtering, the seal ring has air-through hole, the at least two layers of filters are sequentially arranged at one side of the seal ring and communicate with the air-through pipe located at another side of the seal ring via the air-through hole.

2. According to the electronic cigarette in claim 1, wherein any one of the at least two filters is made of chemical fiber, sponge, or breathable foam material.

3. According to the electronic cigarette in claim 2, wherein the chemical fiber includes cellulose acetate fiber, polypropylene fibers, polyester fibers, acetate fibers, viscose fibers, polyamide fibers, polyacrylonitrile fibers, or polyvinyl formal fiber.

4. According to the electronic cigarette in claim 1, wherein the cross-section of any one of the two layers of filters is circular, oval, triangular or polygonal.

5. According to the electronic cigarette in claim 1, wherein any one of two layers of filters has fragrance layer to provide fragrance.

6. According to the electronic cigarette in claim 1, wherein the smoke oil accommodating assembly includes a tubular storing cotton used for storing smoke oil, the storing cotton has through center hole, an oil guiding cotton is assembled in the center hole, the air-through pipe passes through the oil guiding cotton, a fixing pipe is disposed between the air-through pipe and the oil guiding cotton, the atomization assembly partially extends into the air-through pipe.

7. According to the electronic cigarette in claim 6, wherein the atomization assembly includes a battery, an atomization seat, and a heating wire assembly electrically connected with the battery, the atomization seat includes a bottom seat, a center protruding block protruding from a middle of the bottom seat, the center protruding block extends into the air-through pipe, the heating wire assembly passes through the atomization seat and also extends into the air-through pipe, the air-through pipe has hole in a side wall corresponding to the heating wire assembly.

8. According to the electronic cigarette in claim 7, wherein the atomization seat has a cup wall around the center protruding block, the cup wall and the center protruding block to fix one end of the storing cotton and the oil guiding cotton.

9. According to the electronic cigarette in claim 8, wherein the smoke pole has a microphone and light cap at one end thereof contrary to the smoke nozzle assembly.

10. According to the electronic cigarette in claim 2, wherein the smoke oil accommodating assembly includes tubular storing cotton used for storing smoke oil, the storing cotton has through center hole, an oil guiding cotton is assembled in the center hole, the air-through pipe passes through the oil guiding cotton, a fixing pipe is disposed between the air-through pipe and the oil guiding cotton, the atomization assembly partially extends into the air-through pipe.

11. According to the electronic cigarette in claim 3, wherein the smoke oil accommodating assembly includes tubular storing cotton used for storing smoke oil, the storing cotton has through center hole, an oil guiding cotton is assembled in the center hole, the air-through pipe passes through the oil guiding cotton, a fixing pipe is disposed between the air-through pipe and the oil guiding cotton, the atomization assembly partially extends into the air-through pipe.

12. According to the electronic cigarette in claim 4, wherein the smoke oil accommodating assembly includes tubular storing cotton used for storing smoke oil, the storing cotton has through center hole, an oil guiding cotton is assembled in the center hole, the air-through pipe passes through the oil guiding cotton, a fixing pipe is disposed between the air-through pipe and the oil guiding cotton, the atomization assembly partially extends into the air-through pipe.

13. According to the electronic cigarette in claim 5, wherein the smoke oil accommodating assembly includes tubular storing cotton used for storing smoke oil, the storing cotton has through center hole, an oil guiding cotton is assembled in the center hole, the air-through pipe passes through the oil guiding cotton, a fixing pipe is disposed between the air-through pipe and the oil guiding cotton, the atomization assembly partially extends into the air-through pipe.

14. An electronic cigarette, comprising:
a smoke pole having a chamber;
a smoke oil accommodating assembly;
an atomization assembly;
a smoke nozzle assembly, the smoke nozzle assembly, the smoke oil accommodating assembly and the atomization assembly being orderly assembled in the chamber of the smoke pole; and
an air-through pipe capable of guiding atomized smoke oil from the atomization assembly to the smoke nozzle assembly, the air-through pipe being disposed between the smoke nozzle assembly and the atomization assembly;
wherein the smoke nozzle assembly includes a seal piece used for isolating the smoke nozzle assembly and the smoke oil, and at least two layers of filters used for filtering, the seal piece has air-through hole, the at least two layers of filters are orderly arranged at one side of the seal piece and communicate with the air-through pipe located at another side of the seal piece via the air-through hole.

15. According to the electronic cigarette in claim 14, wherein one end of the air-through pipe connects with the atomization assembly, the other end of the air-through pipe extends into the smoke nozzle assembly.
